(19) United States
(12) Patent Application Publication
(10) Pub. No.: US 2015/0237056 A1
(43) Pub. Date: Aug. 20, 2015

(54) MEDIA DISSEMINATION SYSTEM

(71) Applicant: OpenAura, Inc., San Francisco, CA (US)

(72) Inventors: Kevin Arnold, San Francisco, CA (US); David Galitzine King, San Francisco, CA (US); Fayvor Love, Petaluma, CA (US); Harry Dean Hudson, Seattle, WA (US)

(21) Appl. No.: 14/626,645

(22) Filed: Feb. 19, 2015

Related U.S. Application Data
(60) Provisional application No. 61/941,982, filed on Feb. 19, 2014.
(60) Provisional application No. 61/951,444, filed on Mar. 11, 2014.

(51) Int. Cl. H04L 29/06; G06F 17/30

(52) U.S. Cl. CPC H04L 63/101; G06F 17/30864

(57) ABSTRACT

Methods and systems for providing content for a brand to an authorized party via a distributed computer system are disclosed. A plurality of content is curated for a brand wherein the plurality of content has been aggregated from data resulting from a search of a network that, at least in part, seeks out databases with an online profile for the brand. A request is received for a first content for the brand wherein the request is from an authorized party at a content application programming interface (API). The first content is identified among the plurality of content for the brand. The authorized party is provided with access to the first content via the content API.

### RELATED APPLICATIONS

This application claims priority to the co-pending U.S. Provisional Patent Application 61/941,982, Attorney Docket No. OPAU-001.PRO, entitled “MEDIA DISSEMINATION SYSTEM” with the filing date of Feb. 19, 2014, by Kevin Arnold et al., and assigned to the assignee of the present application, which is herein incorporated by reference in its entirety.

This application claims priority to the co-pending U.S. Provisional Patent Application 61/951,444, Attorney Docket No. OPAU-002.PRO, entitled “CONTENT SERVICE APPLICATION PROGRAMMING INTERFACE” with the filing date of Mar. 11, 2014, by Kevin Arnold et al., and assigned to the assignee of the present application, which is herein incorporated by reference in its entirety.

### BACKGROUND

The Internet and other networks host a myriad of data. A brand, artist, or other type of group may have an online presence on the Internet. However, the vast amount of data on the Internet presents challenges that make it difficult to control such an online presence. Moreover, the brand, artist, or other type of group may not have the resources or technical skills needed to manage the online presence.

### BRIEF DESCRIPTION OF THE DRAWINGS

FIG. 1 is a block diagram of an environment for a media dissemination service, in accordance with an embodiment.

FIG. 2 is a flow chart of a method for managing an online presence of a brand via a distributed computer system, in accordance with an embodiment.

FIG. 3 is a flow chart of a method for managing an online presence of a brand via a distributed computer system, in accordance with an embodiment.

FIG. 4 is a flow chart of a method for a media dissemination service, in accordance with an embodiment.

FIG. 5 is a block diagram for a media dissemination service, in accordance with an embodiment.

FIG. 6 is a block diagram for a media dissemination service, in accordance with an embodiment.

FIG. 7 is a flow chart of a method for providing content for a brand to an authorized party via a distributed computer system, in accordance with an embodiment.

FIG. 8 is a flow chart of a method for automatically tagging an item of content via a distributed computer system, in accordance with an embodiment.

The drawings referred to in this description should not be understood as being drawn to scale unless specifically noted.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. On the contrary, the subject matter described herein is intended to cover alternatives, modifications and equivalents, which may be included within the spirit and scope. Furthermore, in the following description, numerous specific details are set forth in order to provide a thorough understanding of the subject matter. However, some embodiments may be practiced without these specific details. In other instances, well-known structures and components have not been described in detail as not to unnecessarily obscure aspects of the subject matter.

Unless specifically stated otherwise as apparent from the following discussions, it is appreciated that throughout the present description of embodiments, discussions utilizing terms such as “searching,” “aggregating,” “normalizing,” “curating,” “providing,” “publishing,” “crawling,” “linking,” “hosting,” “aggregating,” “identifying,” “collecting,” “allowing,” “authorizing,” “requesting,” “identifying,” “determining,” or the like, refer to the actions and processes of a computer system, or similar electronic computing device. The computer system or similar electronic computing device, such as a server computer, a desktop computer, a smart phone, tablet computer, or handheld mobile device, manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, optical and mechanical computers.

### GLOSSARY OF TERMS

The following is a list of definitions for terminology used herein.

Artist—an entity such as a musician or a band.

Brand or Anchor—Artist, Album, Track, Venue, Event, Person, Group, or other entity identifiable in the present technology which collects Particles to form an interface or Aura for the media dissemination service. Any Anchor identifier is usable as a query parameter in the API to retrieve relevant media Particles. The brand may have an online presence.

Curator—an agent that acts on behalf of an online presence, a Brand, or Anchor in configuring Sources and selecting Particles for inclusion in the Brand's Public Aura.

Provider—a social network or content provider that hosts an artist's account, profile, or content relevant to an artist. A “supported” provider is one which the present technology recognize and from which can retrieve artist data in an automated fashion. Automation includes search and retrieval of content using the provider's API or web pages served by the provider.

Source—a given online presence's profile or account on a supported provider. The source is a unit of organization for content collection that, in conjunction with provider-specific content collection code, specifies how to collect content about the given artist from the given provider. A source can be uniquely specified by the triple: provider id, brand id, and the unique identification number (UID) of the brand's account or profile on the provider (it should be appreciated that the components of the triple can be arranged in any order). For Example: The Facebook Account https://www.facebook.com/TaylorSwift associated with Taylor Swift's Aura is a Source; the Twitter Account https://twitter.com/coldplay associated with Coldplay's Aura is a Source.

Online entity—a physical entity such as an artist or bandthat has an online presence in the form of social media, media, information, content, or links to content published on the Internet or other publicly accessible network.

Particle—a media item, or data object containing metadata about a media item. Media items include audio, pictures, images, text, animations, and video. The particle data object contains the id of the artist, the location, URL, of the media in various formats and compression ratios, pixel sizes and other metadata about the media files, information about original provider, attribution information about the media creator, and other metadata about the media and the context in which it was created and published.

Aura—the entire collection of particles the present technology has gathered about and around an Anchor or Brand. The Aura may be referred to as an application programming interface (API) or web service that is used to access the entire collection of particles. The Artist's Public Aura is the set of particles published through the OpenAura about an Artist.

OpenAura API—web service providing metadata in machine-readable format for individual media items and sets of media items; media search, filtration, and sorting capabilities; and Anchor search and metadata. The OpenAura API is the interface between OpenAura and the API customer that is used by the Customer to access the entire collection of particles by making requests for organized (filtered and sorted) subsets of that collection.

API Customer (e.g., authorized party)—Third-party application developer that makes use of media from a Brand's Aura in a consumer application such as a music streaming service or a music discovery service. API Customers are distribution outlets for the media aggregated from Content Providers. Media from an Brand's Aura will often be displayed in an Brand-specific context. E.g., the display of images of an Artist during the streaming of a song by that Artist, or on a page listing the Artist's tour dates.

Normalized content—the structure of information or data related to content or other media is normalized to provide information that is consistent and standard. Metadata may be re-arranged, altered, or generated to create the normalized content.

### Overview of Media Dissemination System

Embodiments of the present technology are for a content distribution manager or system for managing an online presence of a brand via a distributed computer system. The present technology is for aggregating data related to a brand that has an online presence. A brand with an online presence may also be referred to as an online entity. The online entity may be a brand, a musical entity such as a recording artist, a band, a singer, a musical group, politician, political group, athlete, celebrity, or other performing artist. The present technology may also be used to aggregate data for other online entities such as a brand or other type of artist. The aggregated data may be referred to as a body of content or an Aura for a given brand. In one embodiment, the present technology operates to search or crawl the Internet, or other network, for data related to the online entity. The data is aggregated, collected, and cataloged and is then normalized and/or curated to be published or disseminated in an interface. The interface may display actual content related to the online entity or links to such content. The links may be a uniform resource locator (URL). The content may include profile information, audio, video, text, images, pictures, animations, etc. The content may be from any number of sources including public sources, premium content providers, band members, fans, etc.

In one embodiment, the media dissemination service of the present technology allows a brand, brand owner, or agent of the brand access to the interface to modify the content and links that are disseminated via the interface. For purposes of the discussion, the brand, brand owner, or agent of the brand may be referred to as an online entity. The online entity may be required to go through a vetting or authorizing process to prove that they are the online entity. The online entity may then be issued credentials or create credentials to access the interface. The credentials may be used by a member of the band, employees, owners, agents etc. to select content of quality and relevance for syndication. The media dissemination service then delivers media to outlets for display in brand-significant contexts and engages fans with visual media on the interface. The media dissemination service may also pay royalties to brand owners and premium content providers. Brands such as those of music artists and celebrities or other online entities may have promotional and profiling content already published online, the media dissemination service locates that content and collects media references and metadata in a database.

The present technology also provides an authorized party access to content requested by the authorized party. For example, the authorized party goes through an authentication procedure to determine that they are authorized to access a particular piece of content after that content has been searched for, aggregated, and curated by the present technology. Once the authorized party has been authenticated and the requested content identified, access to the requested content is provided. The access may come in the form of streaming, downloading, or linking to a third party location.

The mechanism used for locating published brand-specific content is the Web of Trust, a database of online brand profiles and accounts in conjunction with a web crawler or searcher that follows links to find new content sources. Visual and textual content is indexed and hosted by the media dissemination service in a content database, where a reference to each unique image, video, and text is stored alongside rich metadata about that media item in a data format called a Particle. In one embodiment, a subsystem of the media dissemination system is an auto-curation system that evaluates media during the process of collection and in subsequent reviews, adding descriptive tags to the media metadata, rejecting media of poor quality or brand-relevance, and building indexes for efficient retrieval based on various media attributes, including date of creation, online popularity, and image resolution. To online entities, media dissemination service provides a web-based user interface for further manual curation, allowing for the upload, tagging, filtration, organization, and selection of content for syndication. Content ready and cleared for syndication is made available to application developers through the API, a web service that provides a various request parameters for slicing and sorting the content set according to the needs of the application, offering creative flexibility around content access. The customers of the present technology are companies with applications for web, mobile, television or connected devices that display media delivered by our service in brand-specific contexts. Royalties paid by customers for the use of the API and media files are shared with brand owners and premium content providers. The present technology brokers opportunities for brand promotion and cross-promotion among partners (brands, content providers, and customers) in a media network.

Components of the present technology include:

Web of Trust: a system or method for finding online sources of media content by or about an online entity such as a person or group.

Content Collection: a system or method for retrieving items of media content published online by or about an online entity. The content collection system creates a catalog of references to media hosted by the media dissemination service or third party providers.

Auto-Curation: a system or method for automatically selecting items of media content for syndication to partners in the media network, and tagging such content for easy and efficient further selection and filtration by those partners or developers.

Manual Curation: a system or method allowing curators to manually select, and manually configure auto-selection of, items of media content for syndication to partners in the media network.

Content Service (API): a system or method for distributing items of media content by or about an online entity or a brand to third-party developer for use in an application that displays information about that brand in a brand-specific context. The API enables application developers to select and filter content and create rich visual media experiences for their users.

### Media Dissemination System

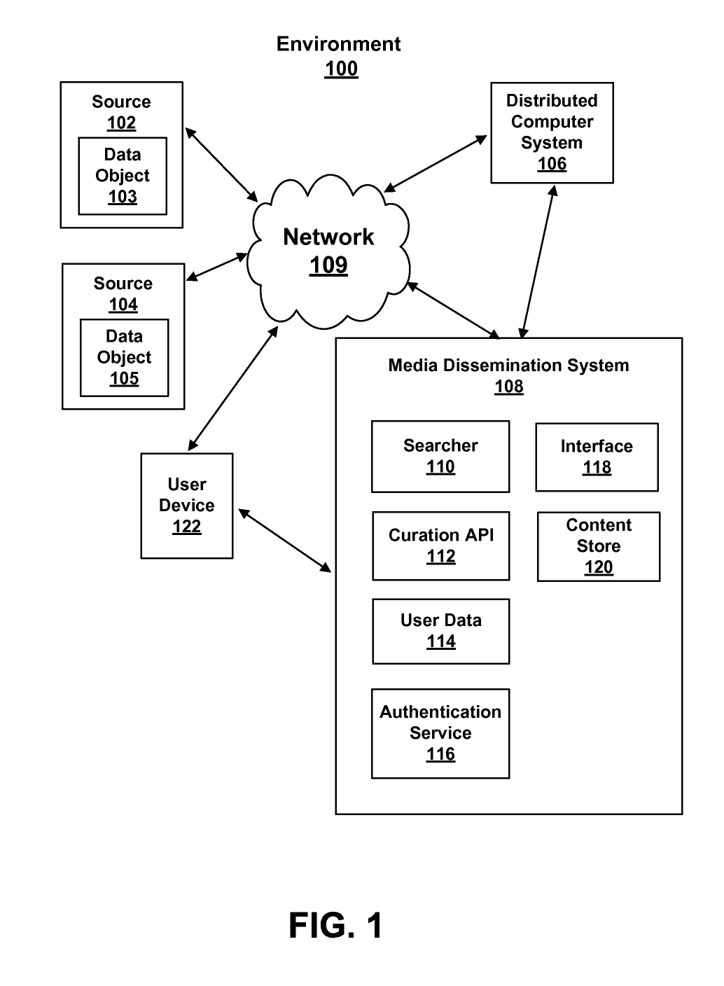

With reference now to FIG. 1, a block diagram of an environment 100 for a media dissemination service. Environment 100 includes source 102, source 104, distributed computer system 106, network 109, media dissemination system 108, searcher 110, curation API 112, user data 114, authentication service 116, interface 118, content store 120, and user device 122. Environment 100 comprises components that may or may not be used with different embodiments of the present technology and should not be construed to limit the present technology. Some or all of the components of environment 100 may be described as hardware components of a media dissemination service.

In one embodiment, source 102 and source 104 are sources of data object 103 and data object 105 respectively. Source 102 and 104 may be databases comprising data objects that are related to an online entity. The data objects may be data such as audio, pictures, images, text, animations, and video. For example, the video may be of a live performance of a song performed by a band where the band is the online entity. Source 102 and 104 may be publicly available or may be private and only accessed with credentials or may be an outlet that delivers content for a fee. Data object 103 and 105 may be content generated by the artist or online entity or may be generated by a third party such as a fan of the online entity. In one embodiment, data object 103 is profile information that describes the online entity such as the date a band was formed or information regarding the discography of the band. In one embodiment, data object 103 has information related to the online entity such as performance dates or where to buy tickets for performances. Source 102 and 104 may be connected to network 109. Environment 100 depicts two sources, but in practice may have any number of sources that have data or content related to an online entity. Network 109 may be the Internet or a private network.

Media dissemination system 108 is a system with hardware components that is used to carry out methods, processes and operations of the present technology. In one embodiment, media dissemination system 108 includes distributed computer system 106. Distributed computer system 106 represents hardware devices such as computer systems, server computers, server farms, etc. Distributed computer system 106 may be described as cloud computing. For example, distributed computer system 106 may represent one, or ten, or any number of computer systems each comprising hardware such as memory and a processors. The distributed computer system 106 may be owned by the same entity that owns media dissemination system 108 or may be owned by a third party.

In one embodiment, searcher 110 searches or crawls network 109 searching for data and content related to an online entity. This may occur under the direction of the online entity or may occur without the knowledge or prior authorization of the online entity. Searcher 110 may employee algorithms to search for specific types of data including content generated by an online entity and profile data associated with the particular online entity. In one embodiment, searcher 110 specifically searches for links to social networks and then uses the links to search for profile data regarding the online entity. In one embodiment, searcher 110 executes Internet searches related to the online entity and employs page ranks to prioritize the data returned by the searches. The searching may be described as a Web of Trust.

In one embodiment, the Web Of Trust describes the addition of brands or anchors into an anchor database, and the identification of social network accounts and online profiles containing content describing the anchor. Each online entity may have a unique Brand added to the database. Uniqueness is established using metadata about the Brand: name, description, hometown, and account or profile on one or more supported provider. When a Brand is added to the database, it is accompanied by links to that Brand's profile or account on one or more supported provider. Media dissemination system 108 accesses public data about the Brand's profile or account on each provider for which the media dissemination system 108 has a link or account name/number. In some cases, this data includes links or account info for other providers (e.g., the Brand's Facebook account links to the Brand's Twitter account). The media dissemination system 108 adds additional Brand profiles or accounts via search or link from an existing known Brand account to another Brand account on different provider.

In one embodiment, media dissemination system 108 aggregates, collects, and/or catalogues the data found by searcher 110. The data or links to the data may then be stored in content store 120 which may be described as physical storage or a database and may be hosted by distributed computer system 106.

Content collection and cataloging describes the way links to media items are added to the particle database or content store 120.

Content Provisioning may be where some providers provide APIs to access content, some provide content feeds along with media metadata. Media dissemination system 108 matches media to one or more Brand's Auras or interface 118 according to matching rules. Those rules include logic for identifier matching, for fuzzy text matching, and for establishing similarity based on brand attributes. For example: for an Artist, attributes such as hometown, twitter account, and band members are used to establish an identity match. Public and Private content may be employed and describes content that is already published online by the Brand is identified using Web of Trust data, and links to this content are recorded and provided in interface 118. Content that has not yet been published is collected from the Brand, Curator, or Content Provider and served by OpenAura through the API. The OpenAura website provides a user interface for submitting media items in single and bulk uploads, and associating media with specific Brands by searching for and selecting the appropriate brand. That interface is available to Curators, Content Providers, and fans.

In one embodiment, interface 118 may be referred to as a content API or a content service API used to provide an authorized party with access to requested content. This may be described as a system and/or method for distributing items of media content by or about a brand to third-party developer for use in an application that displays information about that brand in a brand-specific context. The API enables application developers to select and filter content and create rich visual media experiences for their users.

In one embodiment, the data, or particle is normalized after it is aggregated or collected. This allows the data to be published or displayed in a uniform manner such that each online entity that has an interface or Aura associated with media dissemination system 108 will have display similar data in a uniform fashion. Particle normalization describes metadata about media items is normalized and delivered in a standard format for each media item described by the API. Attribution describes proper attribution and link-back to media creators that is made possible through attribution information provided in media metadata in the API.

In one embodiment, curation API 112 is used to curate the data, content and links that has been searched for, aggregated, and normalized. The data used for curation API 112 may be data object 103 and 105 and may or may not have been normalized. The data may or may not have been found with tags or may have had metadata generated and associated with the data. The data may be the content itself or may be a link back to the content. For example, the data may be an audio file or may be a link or URL to where such an audio file may be purchased. In another example, the content may be a video but the data curated by curation API 112 may be an image representing the video and a link that links to where the video is actually hosted. Thus the curation API 112 and media dissemination system 108 does not have to store content itself. It should be appreciated that the curation performed by curation API 112 may occur automatically or manually.

Auto-Curation describes the way automatic rules are applied to select content for a Brand's Aura or interface 118. In one embodiment, according to certain rules that determine quality and relevance of content, content is selected for inclusion in Aura and profile. Some rules result in the automatic exclusion of content; some result in the tagging of content for filtration or selection by API Customer. For example: images containing text, such as tour posters or promotional banners, are identified and tagged so they can be selected, omitted, or otherwise handled appropriately by the API Developer. Text containing inappropriate language is identified and tagged. Images with faces are tagged with metadata about the artists appearing in the image. Rules may be applied to media items as they are collected and submitted for a Brand's Aura. New media submissions are compared to prior submissions for the identification of duplicates and the re-application of filtration rules to repeat submissions. Tags and media labels are indexed for efficient selection of Particle sets with filters applied on tag values.

A band may designate an individual or individuals as curators for their Aura or interface 118. Manual Curation describes the way Brands or designated curators configure sources for the collection of media and metadata, and select/deselect individual media items and groups of media items for inclusion in or exclusion from their Aura. Brands are provided the capability of adding Sources to their Aura Configuration, which triggers automatic Content Collection to gather data from the added Source. For example: a Twitter account is added to the Aura Configuration for a Brand; tweets from that account are then automatically added as Particles to the Brand's Aura. Brands are given the ability to exclude/include Particles from their Aura on an individual Particle or Particle group basis. Brands assemble particles together to compose a Brand Profile. The Brand Profile may contain Particle sets that are derived using queries against the content database; it may also contain Particles that are dynamically selected on the basis of values of Particle tags and other metadata. For example: Brand Profile is configured to dynamically select the most recent Facebook Profile Photo as the Profile Image and Brand Profile is configured to contain all photos from The Fillmore in one of the Profile's named Particle Collections.

An online entity such as a Brand or artist may be given credentials to access the curation API 112. User data 114 may be used to store the credentials and used by authentication service 116 to authorize a login to curation API 112 or other component of media dissemination system 108.

Interface 118 may refer to the Aura or public interface that is hosted and publically accessible via network 109 by user device 122. User device 122 may be computer system including a mobile computing device such as a tablet or smart phone. In one embodiment, each online entity associated with media dissemination system 108 has a different Aura or interface. Interface 118 may be accessed by user device 122 over network 109 where the interface 118 is hosted directly by media dissemination system 108 or the interface 118 may be host by distributed computer system 106. In one embodiment, user device 122 may directly access the interface from media dissemination system 108. Accessing the interface may be described as content service which is the way content and metadata are served by the interface.

In one embodiment, content metadata is stored in a database and retrieved by a request from interface 118 also described as an API request. Interface 118 requests specify a combination of request parameters that include: Anchor—used to select particles relevant to this Anchor (e.g., Artist, Group, Person, Venue, Event, or Location). For example: the Anchor identifier for the NYC venue CBGB is provided as a request parameter, resulting in Particles referring to images taken at that venue being included in the API response. Examples of parameters include: Source—used to select particles collected from a given Source. Creation Date—limit particles to those created after a given date. Publication Date—limit particles to those published after a given date. Popularity—limit particles to those scoring above a given popularity according to some measure (e.g., number of social media “likes”, downloads, or comments), Story—select particles that adhere to a story line or event sequence by exhibiting high relevance to moments in the story or events in the sequence.

In one embodiment, interface 118 or API requests specify a request parameter to order the resulting particle set, for example: Creation Date—order particles by date of media creation. Post Date—order particles by date of first publication of media. Popularity—order particles by popularity score (e.g., number of Facebook “likes”, or number of Twitter “retweets”). Relevance—order particles by relevance score, calculated by assessing how closely a particle relates to the entity or entities used in an Anchor request parameter. Publication Date—order particles by date of first publication. Story—order particles by narrative. API requests are made by API Customers and licensees for the purpose of enriching user interaction and engagement, such as music exploration, discovery and listening experiences with relevant visual and textual media. For example: Images and text blurbs from an Artist's Aura are shown in slideshow formal while music from that Artist is streamed to an end user using the Radio music service's mobile music streaming application. An Artist's profile image, bio, and scrolling social media particles are shown on the television screen during cable radio song play. An Artist's cover image, bio, and tour image galleries are shown on the Artist page of the iTunes download store. An Artist's most popular images and social media text posts are displayed in rotation in a tiled view during streaming music playback on the Spotify desktop player.

In one embodiment, the present technology employs tagging and labeling techniques that describe the way media items are selected for inclusion in an Aura, and once selected, how they are tagged for filtration by the API Customer, according to various embodiments. It should be appreciated that tags, tagging or labels may also be referred to as metadata associated with media or content. The API customer may refer to a customer of the present technology that accesses a brands Aura on interface 118. The content may be automatically selected for inclusion in an Aura and profile according to a set of rules that determine quality and relevance of content. A brand, having claimed their Aura, may add or remove content manually or configure the content selection rules. Rules governing the inclusion of content in a brand's Aura include, for example, the following:
1. Media from sources identified by the present technology's Web of Trust are included in the Aura.
2. Results of web searches for content relevant to a brand are included in the Aura.
3. Social media posts addressed to the brand or its social media accounts, or containing mentions of the brand, with the exception of negative texts or images, are included in the Aura.
4. Images from stock and editorial image providers such as Getty Images, that are tagged as portraying the brand (e.g., a music artist at the Grammys), are proposed to the brand as candidates for manual inclusion in the Aura.
5. For a musical artist, cover images and liner notes from the artist's published recordings are included in the artist's Aura.

In one embodiment, content that is selected for inclusion in a brand's Aura is then tagged with various attributes (e.g., features) that can be used for later selection or filtration of the particle set. The present technology applies some tags automatically and provides tools for Curators to apply tags manually. The API customer can specify tag values as parameters in an API request for Particles, in order to select a set of particles into, or omit a set of particles from, the API response. For example:
1. Images containing text, such as tour posters or promotional banners, are identified and tagged so they can be selected, omitted, or otherwise handled appropriately by the API Customer. The API customer would choose to omit images containing text from the API response by specifying “images_withtext=exclude” as a parameter=value pair in the API request.
2. Text containing inappropriate language is identified and tagged. The API customer may choose to omit those Particles tagged “explicit” from the API response by specifying this parameter in the API request.
3. Images with faces are automatically tagged with metadata about the artists appearing in the image.
4. Images are labeled with pixel width and height.
5. Images taken during a concert are tagged with the Anchor id of the venue where the concert was held, and if the concert was part of a music festival, the images are tagged with the Anchor id of the Festival.
6. Images created or used in promotion of an Artist's album release are tagged with the Anchor id of the album.
7. An artist may manually associate images, text, or video with a song or track; in this case, the image, text, or video Particle is tagged with the Anchor id of the song or track.
8. Media items are labeled with:
   i. Anchor—the set of Anchors this media item relates to, such as the Venue where an image was taken, or the Brands, Artists, or Persons depicted in an image or mentioned in a text.
   ii. Source (origin).
   iii. Creation Date.
   iv. Attribution string.
   v. Popularity (given a measure of popularity, such as the number of comments or “likes” a media post has received on a social network).

Tags are applied to media items as they are collected and submitted for a Brand's Aura. In one embodiment, new media submissions are compared to prior submissions for the identification of duplicates and the re-application of tags to repeat submissions. In one embodiment, tags and media labels are indexed in the media database for efficient selection of Particle sets.

API Customers use interface 118 to retrieve media and links to media from the present technology's servers and media database, according to various embodiments. Particles of media are organized with tags and labels and retrievable using those tags and labels as parameters in API requests. Metadata about entities used as Particle labels, such as Anchors, Sources, and Providers, is also available via API request. A developer for an API customer may make use of the API using the following sequence:
1. Developer registers for an API key for each Customer Application (App). This key uniquely identifies the App in the present technology's system.
2. Developer forms http requests of the present technology's API using the present technology's SDK or API explorer documentation.
3. Developer writes App or process to make http request of the present technology's API according to the Terms of Use, including limitations on rate of API calls made.
4. Developer uses resulting media links to display media in the Customer App, according to terms of Content Usage that vary with the media being displayed, such as proper attribution and linkback.

In one embodiment, the present technology is able to generate reports regarding API usage. API usage is reported back to the media dissemination system through the mechanisms of pixel tracking and self-reporting.

Pixel tracking is an embodiment where particles returned in an API request for content are logged under a key that is a hash of the following attributes: Customer API Key, Brand Aura identifier, and timestamp. The hash key is sent to the Customer as part of the API response. The present technology provides a reporting endpoint that receives this hash key as a request parameter and returns a single-pixel gif, which may be placed transparently on a page of the Customer App where Particles from the brand are being displayed. When an App user requests the page, the user's browser makes a request to the present technology's API reporting endpoint for the gif. The present technology then registers this access as content usage, and relates it to the particle set that was logged under the hash key.

Self-reporting is an embodiment where, in some instances, it may be necessary or preferable for the API Customer to report content usage from their servers rather than use the pixel-tracking endpoint. One such case may be where content is stored on the client device accessing the Customer App, for offline viewing. For example, the Customer App may be a mobile music playback service with pages showing images of Artists; this may be enabled for music playback and Artist page viewing when the mobile device is not connected to the internet. The present technology provides an API endpoint for self-reporting that uses the same hash-key mechanism as in the pixel-tracking endpoint to identify the sets of Particles used. The API Customer makes a call to this self-reporting endpoint using the hash-key and a usage count representing the number of times the content was accessed by the App user (e.g., in offline mode).

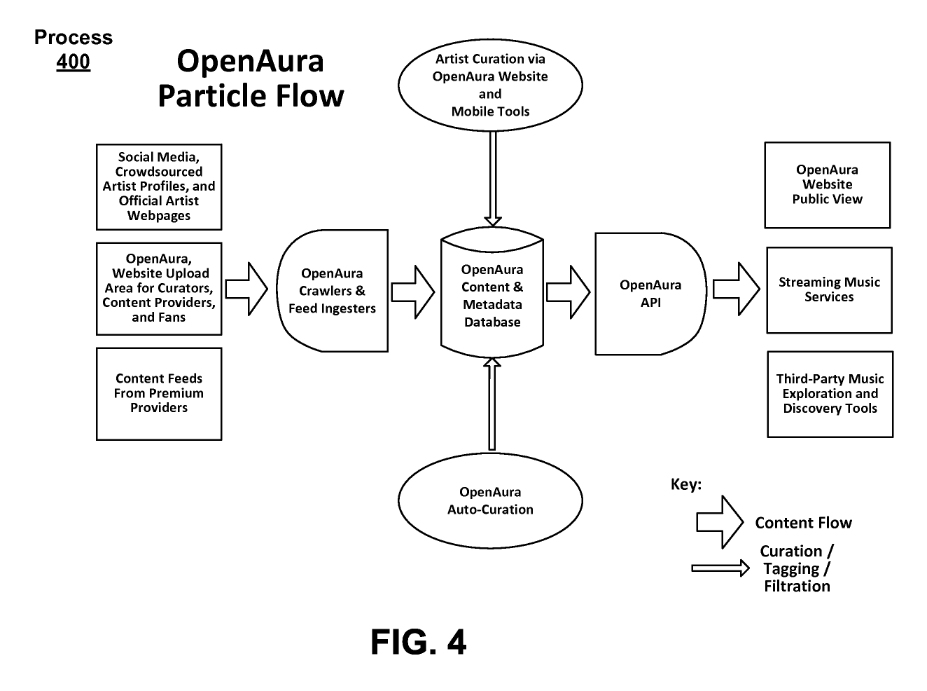

With reference now to FIG. 4, a block diagram of a flow for media dissemination service. FIG. 4 depicts the particle flow of a data that is disseminated by embodiments of the present technology.

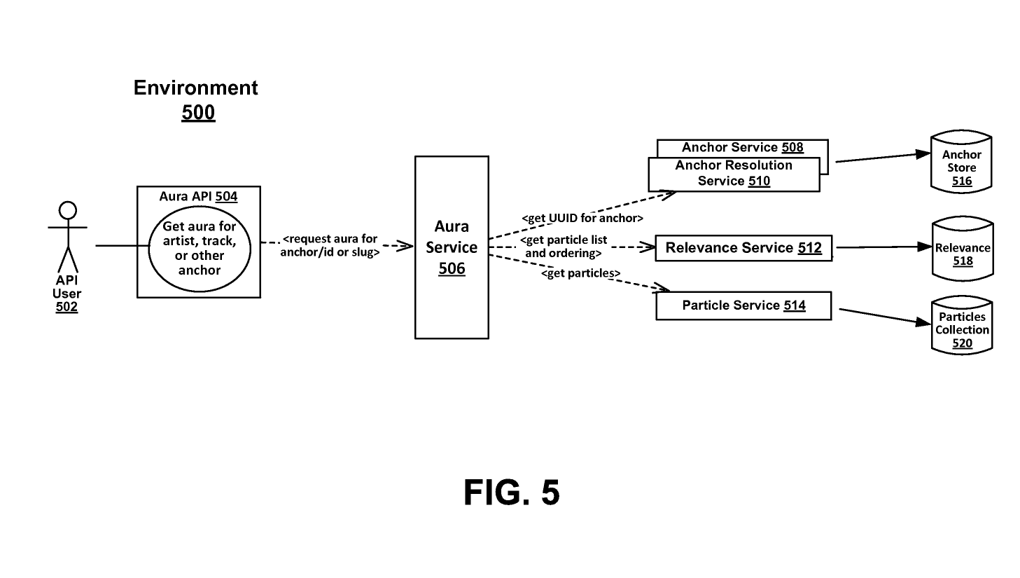

With reference now to FIG. 5, a block diagram of environment 500 which may be described as a media dissemination service or a Particle API Request Flow in accordance with embodiment of the present technology. API user 502 is a user of the present technology that accesses Aura API 504 which is an interface for API user 502 to enter queries and/or view Auras for various brands. Aura API 504 may get or retrieve an Aura for a brand, artist, track, or other anchor in response to a query. The query or request, such as <request aura for anchor/id or slug>, sends a request to Aura Service 506. Depending on the request, Aura Service 506 may take different paths including <get UUID for anchor>, <get particle list and ordering>, and/or <get particles>. In one embodiment, Aura Service 506 communicates with the anchor resolution service 510 via the anchor service 508. Anchor service 508 may be described as an anchor resolution client which is responsible for identifying a brand or anchor in a query and mapping that to the unique id mask system. Anchor service 508 may communicate with anchor store 516 to obtain content or particles. In one embodiment, Aura Service 506 communicates with relevance service 512 which is used to page rank data from relevance 518 which is the ordering of returned particles. In one embodiment, Aura Service 506 communicates with particle service 514 which obtains the actual data or particles from particles collection 520. The particles are returned based on the rankings provided by the relevance service 512.

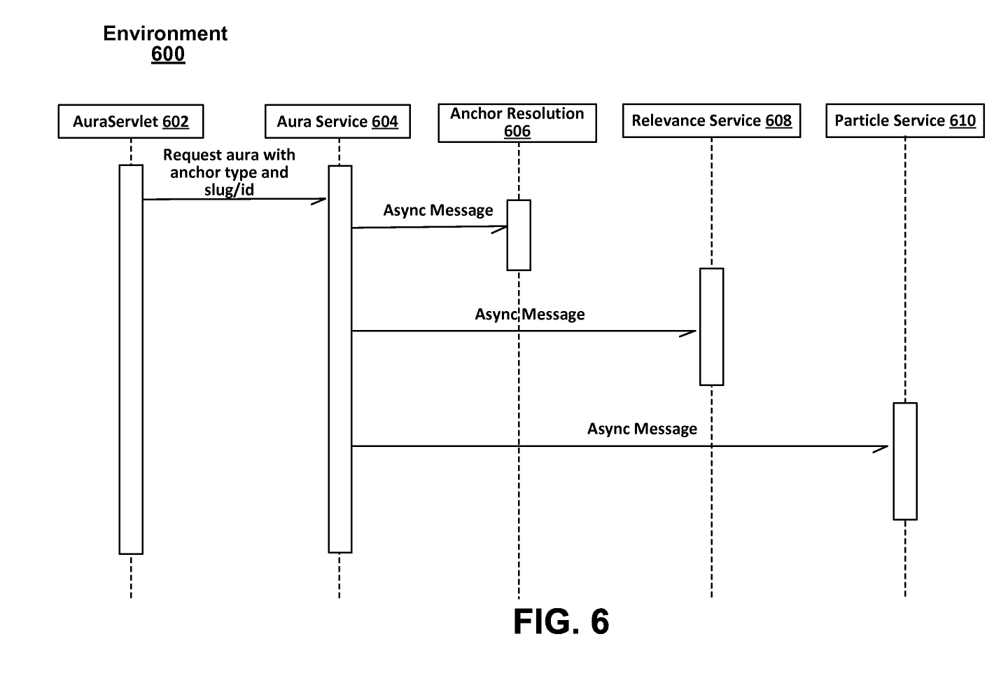

With reference now to FIG. 6, a block diagram of environment 600 representing an actual flow of a query for a media dissemination service such as is represented by environment 500 of FIG. 5 in accordance with embodiment of the present technology. AuraServlet 602, Aura Service 604, Anchor Resolution 606, Relevance Service 608, and Particle Service 610 display the path of several calls for service that are resolving a collection of particles of an Aura in response to a query. For example, the flow may begin with a request at AuraServlet 602 for an aura with anchor type and slug/id. The lines then represent Async Messages of the different services.

### Operations of Media Dissemination System

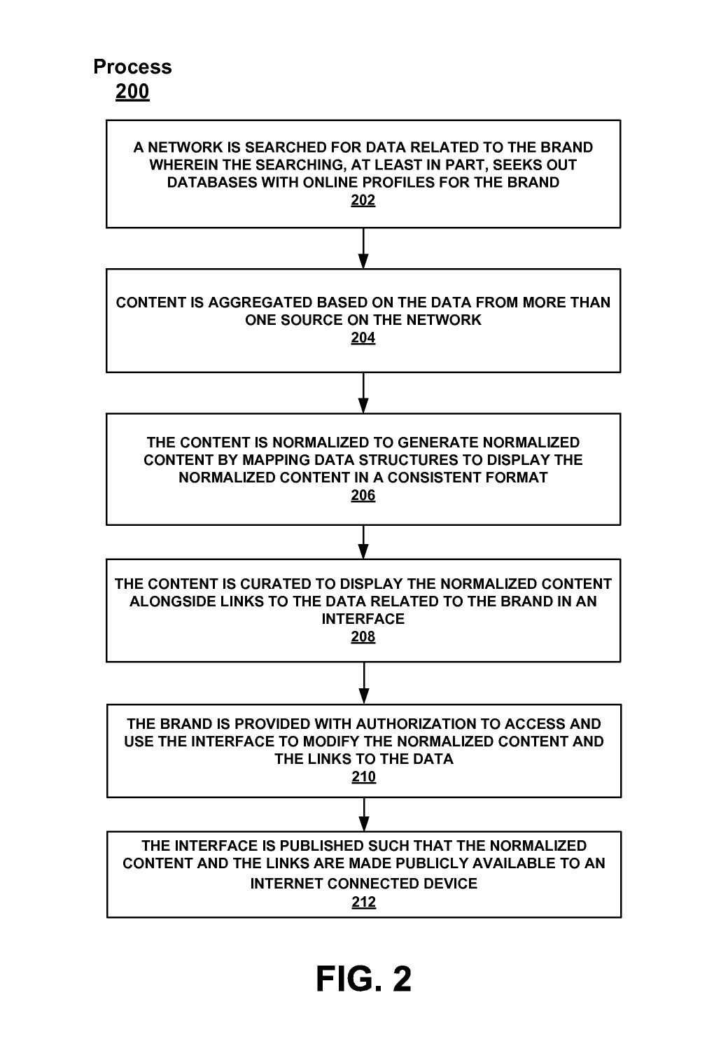

FIG. 2 is a flowchart illustrating process 200 for managing an online presence of a brand via a distributed computer system in accordance with one embodiment of the present technology. In one embodiment, process 200 is a computer implemented method that is carried out by processors and electrical components under the control of computer usable and computer executable instructions. The computer usable and computer executable instructions reside, for example, in data storage features such as computer usable volatile and non-volatile memory. However, the computer usable and computer executable instructions may reside in any type of non-transitory computer usable storage medium. In one embodiment, process 200 is performed by the components of FIG. 1. In one embodiment, the methods may reside in a non-transitory computer usable storage medium having instructions embodied therein that when executed cause a computer system to perform the method.

At 202, a network is searched for data related to the brand wherein the searching, at least in part, seeks out databases with online profiles for the brand. It should be appreciated that embodiments of the present technology are for an online entity such as a brand including a singer, a singing group, a band, an athlete, a celebrity, artist, or a politician. The searching may also be described as crawling. In one embodiment, the network is network 109, the data is data object 103, and is carried out by media dissemination system 108 of FIG. 1. The network may be searched specifically for artist profiles related to the brand hosted by a social media service. By searching for data hosted by a social media service, the present technology has a greater likelihood of finding data that is relevant to the media dissemination system.

At 204, content is aggregated based on the data from more than one source on the network. In one embodiment, the content is aggregated by media dissemination system 108 of FIG. 1. The aggregating may also catalogue the data based on metadata associated with the data. The metadata may be associated with data before it is aggregated or may be generated by media dissemination system 108.

At 206, the content is normalized to generate normalized content by mapping data structures to display the normalized content in a consistent format. The normalized content allows the data to be displayed by interface 118 of FIG. 1 such that interface 118 for a particular brand will display content similar in a manner to that of an interface associated with a different brand such that each interface will appear in a uniform manner. In one embodiment, normalization or normalized content refers to a method or technique used to describe content in a uniformed, standardized, or consistent format. For example, metadata related to or associated with the content is structured in a certain way to describe information about the content. Content may be an image and the metadata may describe where and when the image was taken. Content aggregated from different sources may have metadata that is organized or structured in different ways. The normalization results in the metadata being altered or generated such that the metadata for normalized content is structured in a consistent format. This allows a third party accessing the normalized content from an interface of the present technology to easily access or write code to access or manipulate the normalized content.

At 208, the content is curated to display the normalized content alongside links to the data related to the brand in an interface. For example, interface 118 may not be authorized to display protected content due to copyright or other concerns. Or the content may be too large to host by interface 118. Thus, interface 118 may display content as well as links, URLs, to other locations where the content is stored. It should be appreciated that that the curation may occur automatically or manually. The curation operates to ensure that only relevant content is displayed to the public and also allows the brand to control the content that is displayed.

At 210, the brand is provided with authorization to access and use the interface to modify the normalized content and the links to the data. Access may also be given to modify the metadata associated with the normalized content and the links to the data. The normalized content, the links to the data, and their associated metadata may be referred to as the body of content. The brand or other authorized party may control the content by modifying the data that has been aggregated, normalized, and curated. The modifying may be, but is not limited to, adding, deleting, removing, changing, altering or otherwise modifying.

At 212, the interface is published such that the normalized content and the links are made publicly available to an Internet connected device. The interface may be interface 118 of FIG. 1 and may be accessed via a user device such as user device 122. The user device may be any type of computer device and may access the interface over the Internet or other network. Content may be published in two categories such as public and private. Public content is available to anyone who accesses the interface and private content may be only available to authorized users of the interface. For example, private users may pay for such access and may be able to download or access more content than public users.

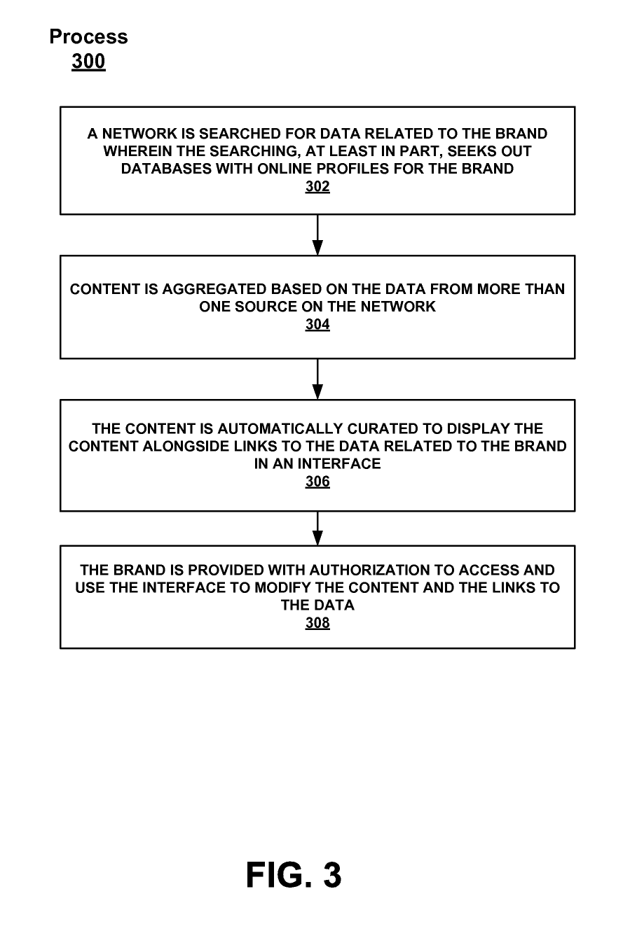

FIG. 3 is a flowchart illustrating process 300 for managing an online presence of a brand via a distributed computer system in accordance with one embodiment of the present technology. In one embodiment, process 300 is a computer implemented method that is carried out by processors and electrical components under the control of computer usable and computer executable instructions. The computer usable and computer executable instructions reside, for example, in data storage features such as computer usable volatile and non-volatile memory. However, the computer usable and computer executable instructions may reside in any type of non-transitory computer usable storage medium. In one embodiment, process 300 is performed by the components of FIG. 1. In one embodiment, the methods may reside in a non-transitory computer usable storage medium having instructions embodied therein that when executed cause a computer system to perform the method.

At 302, a network a searched for data related to the brand wherein the searching, at least in part, seeks out databases with online profiles for the brand. It should be appreciated that embodiments of the present technology are for an online entity such as a brand including a singer, a singing group, a band, an athlete, a celebrity, artist, or a politician. The searching may also be described as crawling. In one embodiment, the network is network 109, the data is data object 103, and is carried out by media dissemination system 108 of FIG. 1. The network may be searched specifically for artist profiles related to the brand hosted by a social media service. By searching for data hosted by a social media service, the present technology has a greater likelihood of finding data that is relevant to the media dissemination system.

At 304, content is aggregated based on the data from more than one source on the network. In one embodiment, the content is aggregated by media dissemination system 108 of FIG. 1. The aggregating may also catalogue the data based on metadata associated with the data. The metadata may be associated with data before it is aggregated or may be generated by media dissemination system 108.

At 306, the content is automatically curated to display the content alongside links to the data related to the brand in an interface. The curation operates to ensure that only relevant content is displayed to the public and also allows the brand to control the content that is displayed. The curation may occur automatically and without requiring the data to be normalized before curating and ultimately published to the interface.

At 308, the brand is provided with authorization to access and use the interface to modify the content and the links to the data. Access may also be given to modify the metadata associated with the content and the links to the data. The content, the links to the data, and their associated metadata may be referred to as the body of content. The brand or other authorized party may control the content by modifying the data that has been aggregated and curated. The modifying may be, but is not limited to, adding, deleting, removing, changing, altering or otherwise modifying.

Process 300 may also include a step to normalize the data before it is curated. In one embodiment, Process 300 includes a step to publish the interface such that the normalized content and the links are made publicly available to an Internet connected device.

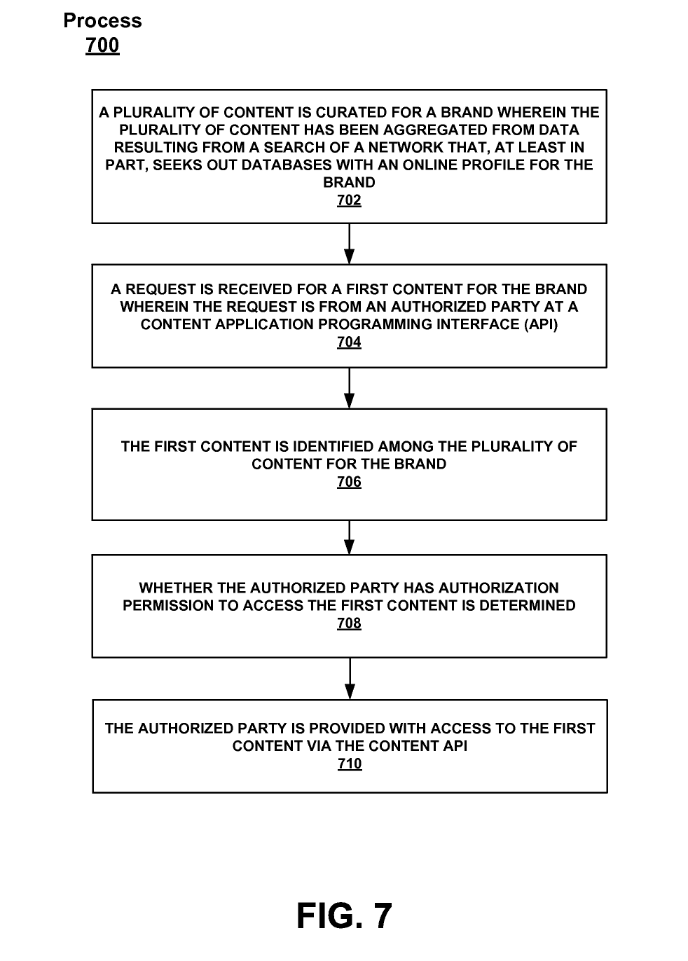

FIG. 7 is a flowchart illustrating process 700 for providing content for a brand to an authorized party via a distributed computer system in accordance with one embodiment of the present technology. In one embodiment, process 700 is a computer implemented method that is carried out by processors and electrical components under the control of computer usable and computer executable instructions. The computer usable and computer executable instructions reside, for example, in data storage features such as computer usable volatile and non-volatile memory. However, the computer usable and computer executable instructions may reside in any type of non-transitory computer usable storage medium. In one embodiment, process 700 is performed by the components of FIG. 1. In one embodiment, the methods may reside in a non-transitory computer usable storage medium having instructions embodied therein that when executed cause a computer system to perform the method.

At 702, a plurality of content is curated for a brand wherein the plurality of content has been aggregated from data resulting from a search of a network that, at least in part, seeks out databases with an online profile for the brand. It should be appreciated that embodiments of the present technology are for an online entity such as a brand including a singer, a singing group, a band, an athlete, a celebrity, artist, or a politician. The search may also be described as crawling. In one embodiment, the network is network 109, the data is data object 103, and is carried out by media dissemination system 108 of FIG. 1. The network may be searched specifically for brand profiles related to the brand hosted by a social media service. By searching for data hosted by a social media service, the present technology has a greater likelihood of finding data that is relevant to the media dissemination system.

In one embodiment, the plurality of content is normalized as part of the searching, aggregating, and curating processes. The normalized content allows the data to be displayed by interface 118 of FIG. 1 such that interface 118 for a particular brand will display content similar in a manner to that of an interface associated with a different brand such that each interface will appear in a uniform manner.

At 704, a request is received for a first content for the brand wherein the request is from an authorized party at a content application programming interface (API). In one embodiment, content API is interface 118 of FIG. 1. The authorized party may be a party that has access to interface 118 that publishes content, links, and other information about the brand. In one embodiment, the access may be public such that any party accessing interface 118 is an authorized party. In one embodiment, the authorized party has paid for or otherwise subscribed to the requested content. For example, the requested content may be a music file that requires payment before the authorized party can receives access.

In one embodiment, the requested content comprises a feature and the identifying process searches the plurality of content for a tag associated with the first content where the tag identifies the features. The feature may also be described as an attribute of the first content. In one embodiment, the tag may be referred to as metadata associated with the first content. The metadata may be automatically generated or associated with the first content or may be entered manually. In one embodiment, the tag pertains to data used or generated by the normalization techniques.

At 706, the first content is identified among the plurality of content for the brand. For example, the plurality of content may be stored in a database associated with the content API such as content store 120 of FIG. 1. Alternatively, the plurality of content may be stored at the source of the content such as source 102 of FIG. 1. The first content is identified by searching the all the content that has been aggregated by searcher 110 of FIG. 1.

At 708, whether the authorized party has authorization permission to access the first content is determined. before the providing occurs. For example, the authorized party may use login credentials in conjunction with authentication service 116 of FIG. 1 to determine what content the authorized party has permission to access. In one embodiment, the permission is determined via a third party service. The third party service may also be the source of where the content is obtained.

At 710, the authorized party is provided with access to the first content via the content API. The access may be provided using any number of techniques for the authorized party to receive the content. For example, the content may be streamed or downloaded from the content API to the authorized party or the authorized party may receive a link to access the content from a third party.

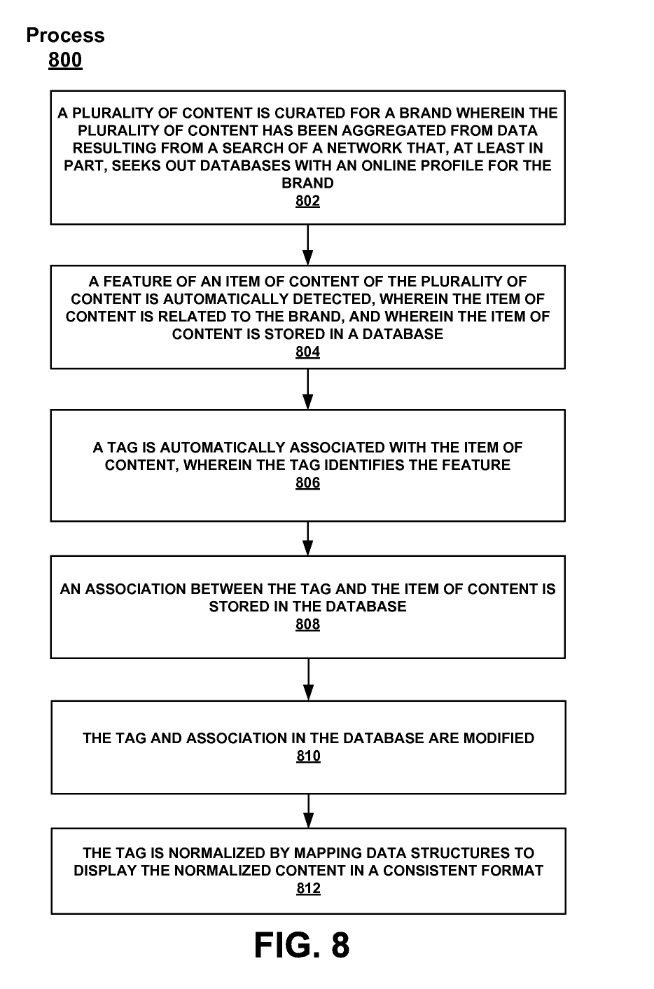

FIG. 8 is a flowchart illustrating process 800 for automatically tagging an item of content via a distributed computer system in accordance with one embodiment of the present technology. In one embodiment, process 800 is a computer implemented method that is carried out by processors and electrical components under the control of computer usable and computer executable instructions. The computer usable and computer executable instructions reside, for example, in data storage features such as computer usable volatile and non-volatile memory. However, the computer usable and computer executable instructions may reside in any type of non-transitory computer usable storage medium. In one embodiment, process 800 is performed by the components of FIG. 1. In one embodiment, the methods may reside in a non-transitory computer usable storage medium having instructions embodied therein that when executed cause a computer system to perform the method.

At 802, a plurality of content is curated for a brand wherein the plurality of content has been aggregated from data resulting from a search of a network that, at least in part, seeks out databases with an online profile for the brand. It should be appreciated that embodiments of the present technology are for an online entity such as a brand including a singer, a singing group, a band, an athlete, a celebrity, artist, or a politician. The search may also be described as crawling. In one embodiment, the network is network 109, the data is data object 103, and is carried out by media dissemination system 108 of FIG. 1. The network may be searched specifically for brand profiles related to the brand hosted by a social media service. By searching for data hosted by a social media service, the present technology has a greater likelihood of finding data that is relevant to the media dissemination system.

At 804, a feature of an item of content of the plurality of content is automatically detected, wherein the item of content is related to the brand, and wherein the item of content is stored in a database. The feature may also be described as an attribute of the item of content.

At 806, a tag is automatically associated with the item of content, wherein the tag identifies the feature. In one embodiment, the tag may be referred to as metadata associated with the item of content. Step 806 describes the metadata being automatically generated or associated with the item of content. In one embodiment, the tag may be entered manually.

At 808, an association between the tag and the item of content is stored in the database. The association allows the item of content to be searched for and found quickly. The association may also allow the content to be displayed, accessed and/or coded to in a uniform consistent manner as related to other items of content.

At 810, the tag and association in the database are modified. The modification may be an update, addition, deletion or other modification to the tag or association. The modification may be a normalization of the tag or the association.

At 812, the tag is normalized by mapping data structures to display the normalized content in a consistent format. The normalized content allows the data to be displayed by interface 118 of FIG. 1 such that interface 118 for a particular brand will display content similar in a manner to that of an interface associated with a different brand such that each interface will appear in a uniform manner.

### API Endpoints

Below is a description of various example OpenAura API endpoints used to make http requests for Anchor and Particle metadata.

/info/a rtists/{id}
Returns profile data including an artist's profile image, bio, and factual data (hometown, members, date of birth or formation, genres, etc.)

### Parameters

id—the OpenAura identifier for this Artist
id_type—is used to indicate the type of ID used to find results. This query recognizes the following id_types:
oa:anchor_id—A 12-byte hexadecimal id, unique to each OpenAura Anchor.
oa:artist_id—An integer id, unique to each Artist.
musicbrainz:gid—A Musicbrainz global identifier for an artist
   /stream/artists/{id}
Returns a paginated list of all particles in an artist's aura, ordered by date-of-post descending

### Parameters

id—the OpenAura identifier for this Artist
id_type is used to indicate the type of ID used to find results. This query recognizes the following id_types:
oa:anchor_id—A 12-byte hexadecimal id, unique to each OpenAura Anchor.
oa:artist_id—An integer id, unique to each Artist.
musicbrainz:gid—A Musicbrainz global identifier for an artist.
   /stream/sources/{id}
Returns a paginated list of all particles collected from the given source, ordered by date-of-post descending

### Parameters

id—the OpenAura identifier for this Source
id_type is used to indicate the type of ID used to find a Source. This query recognizes the following id_types:
oa:source_id—An integer id, unique to each OpenAura Source.
   /search/artists
Returns a paginated list of all artists matching the search criteria, ordered by closeness of match descending

### Parameters

q—the name of the artist as a search string
offset—how many search results to skip before including results in this response
limit—the number of search results to return
/source/artists/{id}
Returns a list of all sources used to gather an artist's aura

### Parameters

id—the OpenAura identifier for this Artist
id_type is used to indicate the type of ID used to find results. This query recognizes the following id_types:
oa:anchor_id—A 12-byte hexadecimal id, unique to each OpenAura Anchor.
oa:artist_id—An integer id, unique to each Artist.
musicbrainz:gid—A Musicbrainz global identifier for an artist.

### API Response Particle Structure

The present technology's API serves media metadata in a normalized format called a Particle. The Particle data structure includes pointers (URLs) to media served online, as well as metadata about the media, such as attribution and image dimensions. Below is an example Particle from the present technology's API.

```
“profile_photo”: {
  “oa_particle_id”: “518a8acbf77648420a000022”,
  “original_post_id”: “10151072956580369”,
  “text”: “ ”,
  “tags”: [ ],
  “source”: {
  “oa_sourcc_id”: 146,
  “url”: “https://www.facebook.com/TaylorSwift”,
  “provider”: {
    “name”: “Faccbook”,
    “url”: “http://facebook.com”
  }
  },
  “oa_artist_id”: 47,
  “profane”: false,
  “date”: “2012-08-28T16:08:36.000Z”,
  “media”: [
  {
    “oa_media_id”: “5315187983ba4d831f09944d”,
    “type”: “image”,
    “url”: “http://photos-c.ak.fbcdn.net/hphotos-ak-
ash2/t1/207212_10151072956580369_1530681729_t.jpg”,
    “width”: 75,
    “height”: 75,
    “mime”: “image/jpeg”
  },
  {
  “oa_media_id”: “5315187983ba4d831f09944e”,
  “type”: “image”,
  “url”: “http://photos-c.ak.fbcdn.net/hphotos-ak-
ash2/t1/207212_10151072956580369_1530681729_s.jpg”,
  “width”: 130,
  “height”: 130,
  “mime”: “image/jpeg”
  },
  {
  “oa_media_id”: “5315187983ba4d831f09944f”,
  “type”: “image”,
  “url”: “http://scontent-a.xx.fbcdn.net/hphotos-
ash2/t1/s720x720/207212_10151072956580369_1530681729_n.jpg”,
  “width”: 720,
  “height”: 720,
  “mime”: “image/jpeg”
  }
  ],
  “popularity”: {
  “likes”: 38607
  }
}
```

### Example Computer System Environment

Portions of the present technology are composed of computer-readable and computer-executable instructions that reside, for example, in computer-usable media of a computer system or other user device. Described below is an example computer system or components that may be used for or in conjunction with aspects of the present technology.

It is appreciated that that the present technology can operate on or within a number of different computer systems including general purpose networked computer systems, embedded computer systems, cloud-based computers, routers, switches, server devices, user devices, various intermediate devices/artifacts, stand-alone computer systems, mobile phones, personal data assistants, televisions and the like. The computer system is well adapted to having peripheral computer readable media such as, for example, a floppy disk, a compact disc, and the like coupled thereto.

The computer system includes an address/data bus for communicating information, and a processor coupled to bus for processing information and instructions. The computer system is also well suited to a multi-processor or single processor environment and also includes data storage features such as a computer usable volatile memory, e.g. random access memory (RAM), coupled to bus for storing information and instructions for processor(s).

The computer system may also include computer usable non-volatile memory, e.g. read only memory (ROM), as well as input devices such as an alpha-numeric input device, a mouse, or other commonly used input devices. The computer system may also include a display such as liquid crystal device, cathode ray tube, plasma display, and other output components such as a printer or other common output devices.

The computer system may also include one or more signal generating and receiving device(s) coupled with a bus for enabling the system to interface with other electronic devices and computer systems. Signal generating and receiving device(s) of the present embodiment may include wired serial adaptors, modems, and network adaptors, wireless modems, and wireless network adaptors, and other such communication technology. The signal generating and receiving device(s) may work in conjunction with one or more communication interface(s) for coupling information to and/or from the computer system. A communication interface may include a serial port, parallel port, Universal Serial Bus (USB), Ethernet port, antenna, or other input/output interface. A communication interface may physically, electrically, optically, or wirelessly (e.g. via radio frequency) couple the computer system with another device, such as a cellular telephone, radio, a handheld device, a smartphone, or computer system.

Although the subject matter is described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for providing content for a brand to an authorized party via a distributed computer system, said method comprising:
curating a plurality of content for a brand wherein said plurality of content has been aggregated from data resulting from a search of a network that, at least in part, seeks out databases with an online profile for said brand;
receiving a request for a first content for said brand wherein said request is from an authorized party at a content application programming interface (API);
identifying said first content among said plurality of content for said brand; and
providing said authorized party with access to said first content via said content API.

2. The method as recited in claim 1, further comprising:
determining whether said authorized party has authorization permission to access said first content before said providing occurs.

3. The method as recited in claim 1, wherein said identifying said first content accesses a database of content for a plurality of brands each having an online presence.

4. The method as recited in claim 1, wherein said request comprises a feature, and wherein said identifying said first content searches said plurality of content for a tag associated with said first content wherein said tag identifies said feature.

5. The method as recited in claim 1, wherein the providing the authorized party with access to said first content is accomplished via sending a link to said authorized party to download said first content from a third party location.

6. The method as recited in claim 1, wherein the providing the authorized party with access to said first content is accomplished via sending said first content to said authorized party.

7. The method as recited in claim 1, wherein said plurality of content has been normalized by mapping data structures to display said normalized content in a consistent format via said content API.

8. A non-transitory computer-usable storage medium having instructions embodied therein that when executed cause a computer system to perform a method for providing content for a brand to an authorized party via a distributed computer system, said method comprising:
curating a plurality of content for a brand wherein said plurality of content has been aggregated from data resulting from a search of a network that, at least in part, seeks out databases with an online profile for said brand;
receiving a request for a first content for said brand wherein said request is from an authorized party at a content application programming interface (API);
identifying said first content among said plurality of content for said brand; and
providing said authorized party with access to said first content via said content API.

9. The non-transitory computer-usable storage medium as recited in claim 8, further comprising:
determining whether said authorized party has authorization permission to access said first content before said providing occurs.

10. The non-transitory computer-usable storage medium as recited in claim 8, wherein said identifying said first content accesses a database of content for a plurality of brands each having an online presence.

11. The non-transitory computer-usable storage medium as recited in claim 8, wherein said request comprises a feature, and wherein said identifying said first content searches said plurality of content for a tag associated with said first content wherein said tag identifies said feature.

12. The non-transitory computer-usable storage medium as recited in claim 8, wherein the providing the authorized party with access to said first content is accomplished via sending a link to said authorized party to download said first content from a third party location.

13. The non-transitory computer-usable storage medium as recited in claim 8, wherein the providing the authorized party with access to said first content is accomplished via sending said first content to said authorized party.

14. The non-transitory computer-usable storage medium as recited in claim 8, wherein said plurality of content has been normalized by mapping data structures to display said normalized content in a consistent format via said content API.

15. A method for automatically tagging an item of content via a distributed computer system, said method comprising:
curating a plurality of content for a brand wherein said plurality of content has been aggregated from data resulting from a search of a network that, at least in part, seeks out databases with an online profile for said brand;
automatically detecting a feature of an item of content of said plurality of content, wherein said item of content is related to said brand, and wherein said item of content is stored in a database;
automatically associating a tag with said item of content, wherein said tag identifies said feature; and
storing an association between said tag and said item of content in said database.

16. The method as recited in claim 15, further comprising:
modifying said tag and association in said database.

17. The method as recited in claim 15, further comprising:
normalizing said tag by mapping data structures to display said normalized content in a consistent format.

18. The method as recited in claim 15, wherein said automatically detecting said feature is a detection of a creation of said item of content.

19. The method as recited in claim 15, wherein said automatically detecting said feature is a detection of a publication of said item of content.

20. The method as recited in claim 15, wherein said database comprises at least one tag that has been received by manual form submission associating said at least one tag with at least one item of content of said plurality of content.
